(19) United States
(12) Patent Application Publication
(10) Pub. No.: US 2003/0194896 A1
(43) Pub. Date: Oct. 16, 2003

(54) Gasket

(76) Inventors: Richard M. Fetcenko, Cortland, OH (US); John M. Chupak, (US); Thomas Edward Gent, (US)

Correspondence Address: THOMAS N. TWOMEY, DELPHI TECHNOLOGIES, INC., Legal Staff, Mail Code: 480-410-202, P.O. Box 5052, Troy, MI, 48007-5052, US

(21) Appl. No.: 10/264,069

(22) Filed: Oct. 3, 2002

Related U.S. Application Data
(60) Provisional application No. 60/372,479, filed on Apr. 15, 2002.

(51) Int. Cl. H01R 13/52

(52) U.S. Cl. 439/271

(57) ABSTRACT

A cellular foam gasket that fills the void space between terminals isolates the terminals of a connection system. Isolation of the terminals and cavities diminishes the possibility of an electrolyte fluid, such as salt water, creating a resistive short between terminals due to the formation of an electrolyte trace or nugget. This invention is a cost effective way to adapt existing lower volt connections to higher voltage systems. The present invention can also be used in entirely new designs.

### TECHNICAL FIELD

The present invention relates to an electrical connection system using a gasket that adapts lower voltage connection systems for application in higher voltage systems.

### BACKGROUND OF THE INVENTION

This application claims priority to U.S. provisional application 60/372,479 filed Apr. 15, 2002.

In response to the need for more power in future vehicles, it is planned for the automotive design voltage to be increased from 14 VDC to 42 VDC. The main objectives for this change are the reduction of fuel consumption and the introduction of new features. Components and systems which work well at 14 VDC will not necessarily function at the higher DC voltage levels.

Connection systems designed for 14 volt systems typically lack one or more design features that enable a connection to operate in a 42 volt environment. Inter alia, connection systems designed for 14 volt systems typically lack sufficient cavity isolation. Cavity isolation diminishes the possibility of an electrolyte fluid, such as salt water, creating a resistive short between terminals in a connector due to the formation of an electrolyte trace or nugget. Without cavity isolation, there is a greater possibility of a failure if an electrolyte solution is introduced into a connection or a primary seal fails. Therefore, current connection systems are not well adapted for 42 volt systems.

### SUMMARY OF THE INVENTION

The present invention provides a cost effective device that can adapt a lower voltage connection system to a higher voltage system.

The present invention comprises a die cut closed-cell foam gasket that is designed to generally fit inside a device it is used to seal. The gasket material is slit to enable the gasket to be inserted through terminal blades without tearing the gasket material. The gasket may be made of silicone or other materials suitable for the environment the gasket is designed to function within.

The connection system of the present invention comprises a housing, terminals extending from the housing, and a sealing member designed to fill the void space between the terminals.

In a preferred embodiment, the connection system of the present invention includes a device having a connector, male terminals, a shroud protecting the male terminals, and a gasket that is compression press fit between the walls of the shroud and the male terminals. This device is designed to mate with a connector having female terminals. If the gasket material is compressible, the female connector is mated to the device and the gasket is further compressed. If the gasket is malleable, but otherwise incompressible, the gasket material will change shape. In either case, the gasket material is designed to generally fill the voids between the terminal to terminal interfaces when the connector housings are mated together. Filling the voids with gasket material eliminates space for electrolyte solution to form an electrolyte trace or nugget between the terminals.

Eliminating the possibility of electrolyte trace formation eliminates a failure mode and makes the connection suitable to operate in a 42 volt environment.

This invention is a cost effective way to adapt existing 14 volt connections to 42 volt systems. It eliminates the need to design and tool new connection systems and enables customers to use off the shelf components in new more severe applications with minimal difficulty. Of course, the present invention can also be used in entirely new designs.

It is thus a feature of the gasket of the present invention that it fills the voids between terminals within a connection system and isolates the terminals from each other. Thus, space for electrolyte solution to form an electrolyte trace or nugget between the terminals is eliminated, accordingly eliminating a severe failure mode.

An advantage of the gasket of the present invention is that the closed-cell foam material that comprises the gasket can be specified to be sufficiently compressible to enable the gasket to function in a connection system even when there is some variation in the distance the gasket may be compressed due to tolerance stack-ups. A typical molded seal is not easily adapted to function in this situation.

Another advantage of the gasket of the present invention is that it is cost effective. It can be used in a new design or used to adapt a lower voltage connection system for application in a higher voltage environment.

### BRIEF DESCRIPTION OF THE DRAWINGS

The present invention will now be described, by way of example, with reference to the accompanying drawings, in which:

FIG. 1 illustrates a gasket of the present invention;

FIG. 2 is a side view of a first connection system of the present invention before the connectors are mated;

FIG. 3 is a side view of FIG. 2 after the connectors are mated;

FIG. 4 is a side view of a second connection system of the present invention before the connectors are mated; and

FIG. 5 is a side view of FIG. 4 after the connectors are mated.

### DETAILED DESCRIPTION OF THE INVENTION

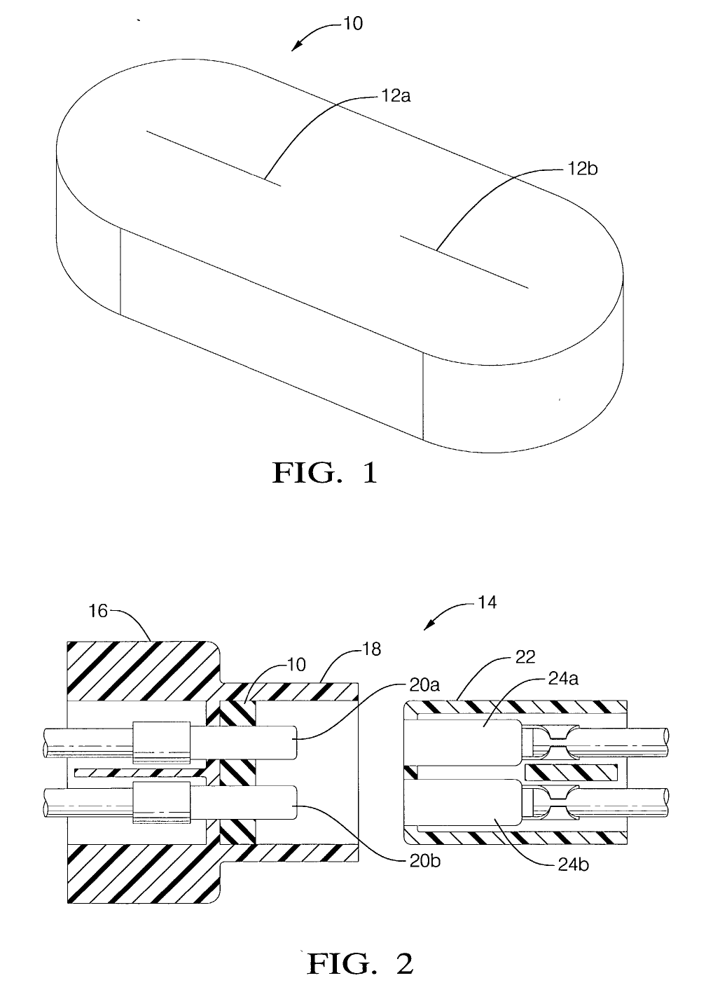

Referring to the figures wherein like numerals refer to like elements throughout the several views, FIG. 1 is a perspective view of a gasket 10. The gasket in FIG. 1 has an elongated shape with slits 12a, 12b to enable the gasket 10 to be inserted through terminal blades (not shown) without tearing the gasket material. The slits 12a, 12b do not extend completely through the gasket 10. This enables a terminal to perforate the partial slit when the gasket 10 is assembled to a device, but retains sealing capabilities if no terminal exists at that location. Alternately, the slits 12a, 12b can be designed to extend entirely through the gasket 10. The shape of the gasket 10 is typically designed so that the gasket 10 fits into a device (not shown) it is used to seal. The gasket is comprised of a cellular foam material that is either a closed-cell foam or, alternatively, an open-cell material that becomes closed-cell when compressed. The foam material may be comprised of silicone or some other material. It is desirable for the foam material to be compressible and to have a compression set that is low enough to enable sealing capabilities to be maintained through vibration and movement experienced in the application environment. One of many materials that may comprise the gasket of the present invention is BISCO™ BF-1000 cellular silicone. BISCO is a trademark of Rogers Corporation, Elk Grove Village, Ill.

FIG. 2 illustrates a first sealed connection system 14 in an unmated state. The first sealed connection system 14 comprises a device 16 (in this example, a male connector) and a female connector 22. The gasket 10 is located inside the male connector 16 and forms a compression fit within the walls of a shroud 18 and male terminals 20a, 20b. Obviously, the female connector might alternatively be used to locate the gasket 10. Also, the gasket 10 may not form a compression fit within the walls of the shroud 18 and may instead be held within the male connector 22 by an adhesive (not shown), by a protrusion (not shown) on the male terminals 20a, 20b or through some other mechanism.

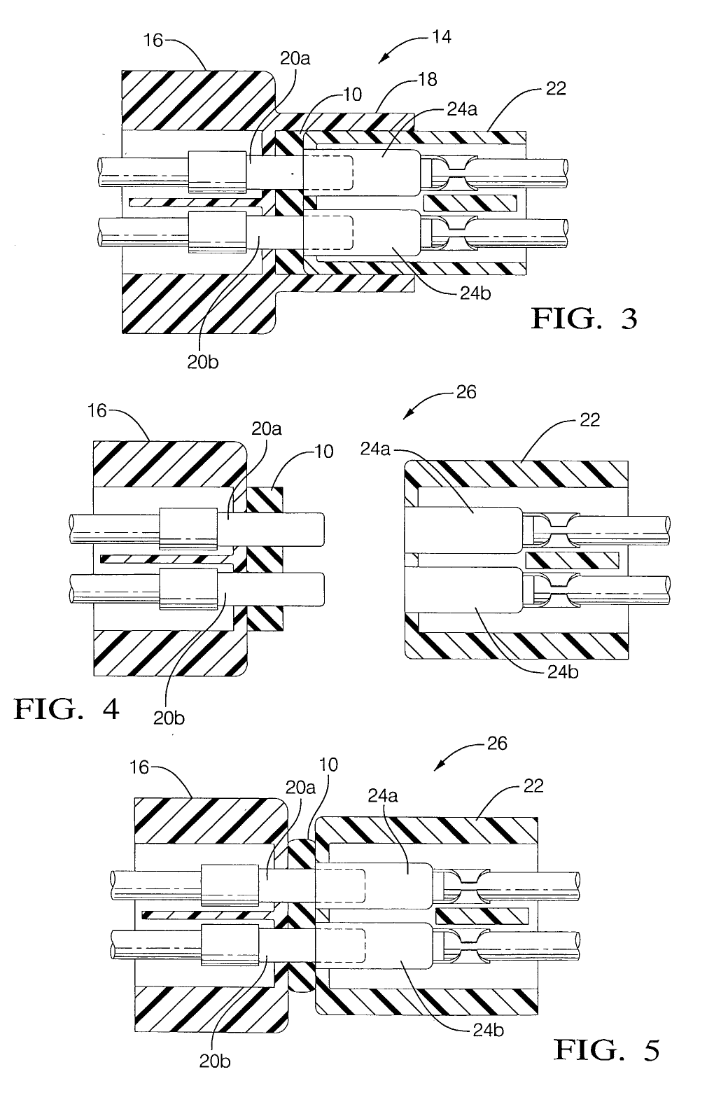

FIG. 3 illustrates a first sealed connection system 14 as depicted in FIG. 2 in a mated state. The gasket 10 fills the voids between the terminals 20a, 20b, 24a, 24b.

FIG. 4 illustrates a second sealed connection system 26 in an unmated state. It is similar to the first sealed connection system 14 in FIG. 2 except that the male connector 16 does not have a shroud. The male terminals 20a, 20b extend through the gasket. The gasket 10 may be held in place by an adhesive (not shown), by a protrusion (not shown) on the male terminals 22a, 22b, frictionally engaged on the terminals, or through some other mechanism.

FIG. 5 illustrates the second sealed connection system 26 as depicted in FIG. 4 in a mated state. The gasket 10 fills the voids between the terminals 20a, 20b, 24a, 24b.

This invention has been described with reference to a preferred embodiment and modifications thereto. Further modifications and alterations may occur to others upon reading and understanding the specification. It is intended to include all such modifications and alterations insofar as they come within the scope of the invention.

Having thus described the invention, what is claimed is:

1. A sealing member for use in an electrical connection system having at least one terminal, said sealing member being comprised of a cellular foam material preformed with at least one opening for receiving said at least one terminal.

2. The sealing member of claim 1, wherein said cellular foam material comprises silicone.

3. The sealing member of claim 1, wherein said cellular foam material comprises a closed-cell foam material.

4. The sealing member of claim 1, wherein said cellular foam material comprises an open-cell foam material that becomes closed-cell when compressed.

5. The sealing member of claim 1, wherein said cellular foam material comprises BF-1000 cellular silicone.

6. The sealing member of claim 1, including a second terminal, said sealing member being a shape that generally fills the void space between said at least one terminal and said second terminal.

7. The sealing member of claim 1, said cellular foam material having generally opposite sides, wherein at least one opening extends between said generally opposite sides.

8. An electrical connection system comprising:
a housing,
at least one terminal projecting from said housing, and
a sealing member located at least partially over said at least one terminal, said sealing member being comprised of a cellular foam material preformed with at least one opening for receiving said at least one terminal.

9. The electrical connection system of claim 8, including a second terminal, said sealing member being a shape that generally fills the void space between said at least one terminal and said second terminal.

10. The electrical connection system of claim 8, wherein said cellular foam material comprises silicone.

11. The electrical connection system of claim 8, wherein said cellular foam material comprises a closed-cell foam material.

12. The electrical connection system of claim 8, wherein said cellular foam material comprises an open-cell foam material that becomes closed-cell when compressed.

13. The electrical connection system of claim 8, wherein said cellular foam material comprises BF-1000 cellular silicone.

14. An electrical connection system comprising:
first and second connectors, each of said connectors having at least one terminal adapted to matingly interengage with the other of said at least one terminal, and a sealing member located at said first connector and having at least one opening for said terminals.

15. The electrical connection system of claim 14, wherein said sealing member comprises a closed-cell foam material.

16. The electrical connection system of claim 14, wherein said sealing member comprises an open-cell foam material that becomes closed-cell when compressed.

17. An electrical connection system comprising:
at least one connector having a shroud, and
a gasket being at least partially within said shroud, said gasket being comprised of a cellular foam material.

18. The electrical connection system of claim 17, further comprising at least one terminal projecting from said at least one connector, wherein said at least one terminal at least partially extends through said gasket.

19. The electrical connection system of claim 17, wherein said cellular foam material comprises a closed-cell foam material.

20. The electrical connection system of claim 17, wherein said cellular foam material comprises an open-cell foam material that becomes closed-cell when compressed.

21. The electrical connection system of claim 17, wherein said cellular foam material comprises BF-1000 cellular silicone.
